(19) United States
(12) Patent Application Publication
(10) Pub. No.: US 2011/0031443 A1
(43) Pub. Date: Feb. 10, 2011

(54) Multicomponent carbon nanotube-polymer complex, composition for forming the same, and preparation method thereof

(76) Inventors: Jong Jin Park, Yongin-si (KR); Byeongyeol Kim, Uiwang-si (KR); Dong Woo Shin, Yongin-si (KR); Young Ju Kim, Yongin-si (KR)

Correspondence Address: HARNESS, DICKEY & PIERCE, P.L.C., P.O. BOX 8910, RESTON, VA, 20195, US

(21) Appl. No.: 12/923,925

(22) Filed: Oct. 14, 2010

Related U.S. Application Data
(62) Division of application No. 11/878,064, filed on Jul. 20, 2007.

(30) Foreign Application Priority Data
Oct. 13, 2006 (KR) 10-2006-0099942

(51) Int. Cl. H01B 1/12; C08K 5/1515; C08K 5/1539; C08K 5/151; C08K 5/07; B29C 45/00; B29C 47/00; B29C 39/00; B82Y 99/00

(52) U.S. Cl. 252/500; 524/114; 524/112; 524/107; 524/358; 264/328.1; 264/320; 264/299; 977/773; 977/748

(57) ABSTRACT

A multicomponent carbon nanotube-polymer complex, a composition for forming the same, and a preparation method thereof are disclosed herein. A multicomponent carbon nanotube-polymer complex may include carbon nanotubes surface-modified with double bond-containing functional groups or carbon nanotubes surface-modified with oxirane groups and/or carbon nanotubes surface-modified with anhydride groups; a polymer binder; and/or acid-treated carbon nanotubes and/or pristine carbon nanotubes. The multicomponent carbon nanotube-polymer complex may exhibit remarkably improved mechanical and hardening properties, compared with conventional complexes using only carbon nanotubes and a polymer binder, and thus may be advantageously used as an electromagnetic wave shielding material and a conductive material.

### PRIORITY STATEMENT

This application is a divisional under 35 U.S.C. §121 of U.S. application Ser. No. 11/878,064, filed on Jul. 20, 2007, which claims priority under 35 U.S.C. §119 to Korean Patent Application No. 10-2006-0099942, filed on Oct. 13, 2006 with the Korean Patent Office, the contents of each of which are incorporated herein in their entirety by reference.

### BACKGROUND

1. Technical Field

Example embodiments relate to a multicomponent carbon nanotube-polymer complex, a composition for forming the same, and a preparation method thereof. Example embodiments include a multicomponent carbon nanotube-polymer complex that may be used as an improved electromagnetic wave shielding material and a conductive material, a composition for forming the same, and a preparation method thereof.

2. Description of the Related Art

Many studies on carbon nanotubes have been conducted since carbon nanotubes were discovered by Dr. Iijima at Maijo University of Japan in 1991 during his research with electron microscopy. Generally, a carbon nanotube may be a graphite sheet in the form of a hollow, cylindrical structure with an inner diameter of about 1 to about 20 nm. Graphite has the shape of a rigid and flat hexagonal sheet due to the structure of the covalent bonds between the carbon atoms. The upper and lower portions of the sheet may be filled with free electrons that move in parallel with the sheet in a discrete state. To form carbon nanotubes, the graphite sheet may be configured to be spirally wound, therefore forming edge bonds at different points. Furthermore, electrical properties of carbon nanotubes were reported to be a function of their structure and diameter. It was observed that carbon nanotubes may display various electrical characteristics from insulators to semiconductors and conductors depending on their structure and diameter. Therefore, changing the spiral shape or chirality of the carbon nanotube may result in a change in the motion of the free electrons, thus enabling the free electron motion to become completely free. The range of barrier voltage for free electrons depends on the tube's diameter. In the case of a relatively small tube diameter, the voltage may be as low as about 1 eV. Accordingly, the carbon nanotubes may be suitable candidates for use in flat panel displays, transistors, energy storage materials, and the like, because they show increased mechanical robustness and chemical stability, exhibit both semiconductor and conductor properties, and have a hollow cylindrical structure with a relatively small diameter and a relatively long length. In addition, by virtue of the above characteristics, the possible application fields of carbon nanotubes in nano-size electronic devices may be diverse.

### SUMMARY

Example embodiments disclose a multicomponent carbon nanotube-polymer complex with improved mechanical and electrical properties and that may be efficiently used as an electromagnetic wave shielding material and a conductive material, a composition for forming the multicomponent carbon nanotube-polymer complex, and a preparation method thereof.

Example embodiments herein disclose a multicomponent carbon nanotube-polymer complex. A multicomponent carbon nanotube-polymer complex may include carbon nanotubes surface-modified with double bond-containing functional groups and a polymer binder. A multicomponent carbon nanotube-polymer complex may include carbon nanotubes surface-modified with double bond-containing functional groups; a polymer binder; and acid-treated carbon nanotubes and/or pristine carbon nanotubes. A multicomponent carbon nanotube-polymer complex may include carbon nanotubes surface-modified with oxirane groups and/or carbon nanotubes surface-modified with anhydride groups; a polymer binder; and acid-treated carbon nanotubes and/or pristine carbon nanotubes. A multicomponent carbon nanotube-polymer complex may further include metallic nanoparticles.

Example embodiments herein disclose a composition for forming the multicomponent carbon nanotube-polymer complex. A composition may include carbon nanotubes surface-modified with double bond-containing functional groups; a polymer binder; and a crosslinking agent, (e.g., radical initiator). A composition may include carbon nanotubes surface-modified with double bond-containing functional groups; a polymer binder; acid-treated carbon nanotubes and/or pristine carbon nanotubes; and a radical initiator. A composition may include carbon nanotubes surface-modified with oxirane groups and/or carbon nanotubes surface-modified with anhydride groups; a polymer binder; acid-treated carbon nanotubes and/or pristine carbon nanotubes; and a crosslinking agent (e.g., thermal hardener). A composition may further include an organic solvent. A composition may further include one or more additives selected from the group consisting of metallic nanoparticles, coupling agents, dyes, fillers, flame-retarding agents, dispersing agents, and wetting agents.

Example embodiments herein disclose a method for preparing the multicomponent carbon nanotube-polymer complex. A method may include (a) preparing the composition for forming a multicomponent carbon nanotube-polymer complex and (b) mixing and curing the composition by a mechanical method to obtain a multicomponent carbon nanotube-polymer complex. A method may include (a) preparing the composition for forming a multicomponent carbon nanotube-polymer complex, which further includes an organic solvent, and (b) coating the surface of a substrate with the composition and curing the composition to obtain a multicomponent carbon nanotube-polymer complex.

### DETAILED DESCRIPTION

It will be understood that when an element or layer is referred to as being “on”, “connected to”, “coupled to”, or “covering” another element or layer, it may be directly on, connected to, coupled to, or covering the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, e.g., “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in more detail with reference to the accompanying illustrations.

Example embodiments herein disclose a multicomponent carbon nanotube-polymer complex. A multicomponent carbon nanotube-polymer complex may include carbon nanotubes surface-modified with double bond-containing functional groups and a polymer binder. A multicomponent carbon nanotube-polymer complex may include carbon nanotubes surface-modified with double bond-containing functional groups; a polymer binder; and acid-treated carbon nanotubes and/or pristine carbon nanotubes. A multicomponent carbon nanotube-polymer complex may include carbon nanotubes surface-modified with oxirane groups and/or carbon nanotubes surface-modified with anhydride groups; a polymer binder; and acid-treated carbon nanotubes and/or pristine carbon nanotubes.

A multicomponent carbon nanotube-polymer complex may include i) surface-modified carbon nanotubes with functional groups having a double-bond capable of causing radical polymerization by heat, or oxirane groups or anhydride groups capable of causing ring opening polymerization (epoxy curing) by heat; ii) a polymer binder capable of providing binding affinity, adhesiveness, and various functionalities; iii) acid-treated carbon nanotubes showing high heat resistance and/or iv) pristine carbon nanotubes endowing their own inherent properties, and may form interpenetrating polymer network structures between the carbon nanotubes or the carbon nanotubes and the polymer binder through radical polymerization by heat or heatcuring, thereby exhibiting improved effects in terms of mechanical, curing and thermal properties, and electrical characteristics.

The multicomponent carbon nanotube-polymer complex may be efficiently used, for example, in the formation of a conductive film or a conductive pattern, and further advantageously employed in various fields, including antistatic adhesive sheets or shoes, conductive polyurethane print rollers, electromagnetic wave shielding EMI, and the like.

Hereinafter, the ingredients that may be included in the multicomponent carbon nanotube-polymer complex, though not limited thereto, will be described in more detail.

The carbon nanotubes surface-modified with double bond-containing functional groups may be carbon nanotubes whose surfaces have been modified with any functional group containing one or more double bonds between carbons (C═C) and/or carbon and oxygen (C═O). Because double bond-containing functional groups may be introduced onto the surfaces of the carbon nanotubes, crosslinking bonds may occur between the double bonds in the curing reaction due to radicals generated by heat, and thus, interpenetrating polymer network structures may be formed between the carbon nanotubes or the carbon nanotubes and the polymer binders, which provide improved mechanical properties to the multicomponent carbon nanotube-polymer complex.

At this time, the double bond-containing functional group may be represented by the following Formula 1, more particularly, Formula 2 or 3, but is not necessarily limited thereto.

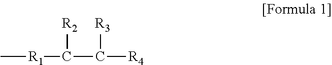

wherein R₁ is C₁₋₁₅ linear, branched, or cyclic alkylene or C₁₋₁₅ linear, branched, or cyclic alkylene containing one or more of C, C═O, O, N, and benzene in at least one of a main chain and a side chain; and R₂, R₃ and R₄ are independently H or C₁₋₁₅ linear, branched, or cyclic alkyl.

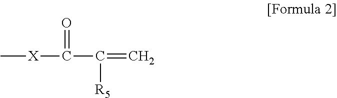

wherein X is O or NH; and R₅ is H or CH₃; and

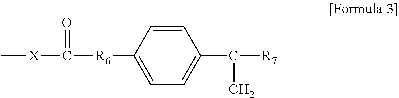

wherein X is O or NH; R₆ is C₁₋₆ linear, branched, or cyclic alkylene; and R₇ is H or CH₃.

Furthermore, the carbon nanotubes surface-modified with oxirane groups or anhydride groups may be carbon nanotubes whose surfaces have been modified to have any oxirane group or anhydride group including a ring structure capable of causing ring opening polymerization by heat. Because the oxirane groups or anhydride groups of the ring structure may be introduced onto the surfaces of the carbon nanotubes, crosslinking bonds occur between the functional groups in the heatcuring reaction, and thus, interpenetrating polymer network structures may be formed between the carbon nanotubes or the carbon nanotubes and the polymer binders. As a result, the carbon nanotubes may provide increased mechanical properties to the multicomponent carbon nanotube-polymer complex.

The oxirane group may be illustrated by the following Formula 4, and the anhydride group may be illustrated by one of the following Formulas 5 to 10, but are not necessarily limited thereto.

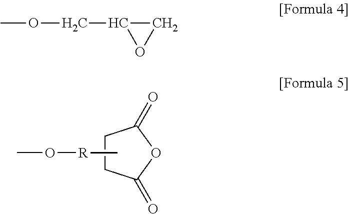

wherein R is C₁₋₁₅ linear, branched, or cyclic alkylene; and

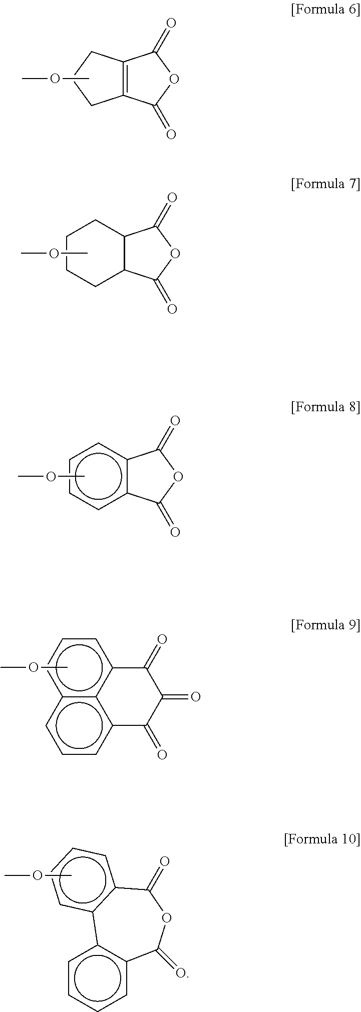

The carbon nanotubes surface-modified with double bond-containing functional groups and the carbon nanotubes surface-modified with oxirane groups or anhydride groups may be obtained by treating the surface of the carbon nanotube with an acid, followed by introducing each functional group thereinto.

The methods for treating the surface of the carbon nanotube with an acid and introducing each functional group onto the surface of the acid-treated carbon nanotube may be conducted by conventional methods known or appreciated in the art, and may be performed according to the following procedure, but are not limited thereto.

Carbon nanotubes may be refluxed in a mixed acid solution of nitric acid and sulfuric acid at a volume ratio of about 1:9-9:1, for example about 2:8-8:2, for about 24-120 hrs, and filtered through a polycarbonate filter having a pore size of about 0.1-0.4 μm, for example about 0.2 μm. The filtrate thus obtained may be refluxed again in nitric acid at about 80-120° C. for about 45-60 hrs followed by centrifugation. After centrifugation, a supernatant may be recovered and filtered through a polycarbonate filter. The filtrate thus obtained may be dried to obtain the carbon nanotubes. The dried acid-treated carbon nanotubes may be dispersed in distilled water or dimethylformaldehyde (DMF), and the dispersion may be filtered again through a polycarbonate filter so as to select acid-treated carbon nanotubes having a uniform size.

With regard to introducing double bond-containing functional groups, the acid-treated carbon nanotubes may be added to a conventional organic solvent, including DMF, 4-hydroxy-4-methyl-2-pentanone, ethylene glycol monoethyl ether and 2-methoxyethanol, or the like, and then uniformly dispersed therein by ultrasonification. A suitable catalyst may be dissolved in the same organic solvent and added to the reactor containing the carbon nanotube dispersion, and the reaction mixture may be sufficiently agitated. The catalyst may be appropriately selected depending on the type of double bond-containing functional group represented by Formula 1. Compounds including the double bond-containing functional groups dissolved in the same organic solvent may be agitated while being slowly added to the reaction mixture, and the reaction may be continued for about 7-36 hrs (e.g., about 24 hrs) at room temperature. If the reaction is exothermic, it may be desirable to remove the heat generated during the reaction by using an ice-bath. After the reaction is completed, distilled water may be added to the reaction mixture, and precipitate may be recovered by filtration through a polycarbonate filter. The recovered precipitate may be washed again with water and diethylether several times so as to remove unreacted compounds including the double bond-containing functional group, followed by drying under reduced pressure at room temperature. As a result, carbon nanotubes whose surfaces have been modified with double bond-containing functional groups may be obtained.

With regard to introducing oxirane groups or anhydride groups, the acid-treated carbon nanotubes may be added to a conventional organic solvent and evenly dispersed by ultrasonification. For easy introduction of oxirane or anhydride, the hydroxyl terminal of the carboxyl group on the surface of the carbon nanotube may be substituted with chlorine by adding thionyl chloride to the carbon nanotube dispersion and sufficiently stirring the mixture at about 60-80° C. for about 20-30 hrs. Upon completion of the reaction, the reaction mixture may be diluted with anhydrous THF and centrifuged to discard the supernatant. The remaining precipitate may be washed and rinsed again with anhydrous THF several times, and the resulting black solid matter may be subjected to vacuum drying at room temperature to obtain chlorinated carbon nanotubes. Next, the chlorinated carbon nanotubes may be dispersed in an organic solvent (e.g., chloroform or dimethyl formamide) and then subjected to a reflux reaction with an oxirane compound (e.g., glycidol) in the presence of a base catalyst (e.g., pyridine) for about 30-60 hrs to thereby obtain carbon nanotubes modified with oxirane groups. Alternatively, the chlorinated carbon nanotubes, which may be dispersed in an organic solvent, including chloroform or dimethyl formamide, may be subjected to a reaction with a dimethyl ester derivative having a hydroxyl group at one end thereof to obtain carbon nanotubes modified with dimethyl ester groups, which may be converted into dicarboxylic acid through a reaction with water in the presence of sodium hydroxide. A subsequent condensation reaction of the dicarboxylic acid yields carbon nanotubes modified with anhydride groups.

Upon completion of each reaction, the carbon nanotubes may be rinsed with a solvent (e.g., methanol) several times to wash off the remnant of the reactants. The presence of oxirane or anhydride group on the surface of the carbon nanotube may easily be confirmed by Raman spectrum.

The surface-modified carbon nanotubes, via introduction of double bond-containing functional groups, and the surface-modified carbon nanotubes with oxirane groups or anhydride groups, may be optionally included in the complex at a proper ratio (e.g., about 0.01-65% by weight) by considering the uses and cases thereof. If the amount of the carbon nanotube substantially exceeds the range, excessive curing may occur or unreacted residues may be generated, thus interfering with an efficient curing reaction.

The acid-treated carbon nanotubes may be treated with a strong (concentrated) acid, including nitric acid, sulfuric acid, or a mixture thereof, under refluxing. The acid-treated carbon nanotubes may be obtained by the same method as described above, and it may be advantageous to employ the surface-modified carbon nanotubes with carboxyl groups. Unlike the conventional thermal hardeners or radical initiators in the form of a monomer or an oligomer being apt to be degraded during the curing reaction, because such acid-treated carbon nanotubes may be very stable to heat, they may remain without incurring any degradation during the curing reaction and stimulate the action of the thermal hardeners or radical initiators. As a result, the acid-treated carbon nanotubes may endow a carbon nanotube-polymer complex with higher thermostability and increased mechanical and hardening properties.

The acid-treated carbon nanotubes may be selectively included in the complex at a proper ratio by taking into account the uses and cases thereof. For example, the acid-treated carbon nanotubes may be included in the amount of about 0.01-65% by weight. If the amount of the acid-treated carbon nanotube substantially exceeds the range, excessive curing may occur or unreacted residues may be generated, thus interfering with an efficient curing reaction.

The pristine carbon nanotubes refer to carbon nanotubes that have not undergone chemical modification treatment, unlike the above-mentioned acid-treated carbon nanotubes, and function to fully confer their own inherent properties upon a carbon nanotube-polymer complex.

The carbon nanotubes that may be used are not limited to those disclosed in the examples and may include all suitable commercially-available products so long as they are able to serve their intended purpose. For example, the carbon nanotubes may be selected from the ones produced by the general arc discharge method, laser ablation method, high temperature filament plasma chemical vapor deposition method, microwave plasma chemical vapor deposition method, thermal chemical vapor deposition method, and thermal decomposition method. However, because the carbon nanotubes prepared by the above methods may be contaminated with carbon-containing by-products, including amorphous carbon and fullerene as well as transition metal catalysts necessary for the tube's growth, a separate purifying process may be required to remove them.

Carbon nanotubes may be purified with methods known or appreciated in the art and are not limited to the following method. Carbon nanotubes may be refluxed in distilled water at about 100° C. for about 8-24 hrs, for example about 12 hrs, and then recovered by filtration. The recovered carbon nanotubes may be completely dried and washed with toluene to remove carbon-containing by-products. Thereafter, the resulting soot may be heated at about 470° C. for about 20-30 minutes, for example about 20 minutes, and lastly washed with about 6 M HCl (hydrochloric acid) solution to completely remove metallic impurities. As a result, the pristine carbon nanotubes may be obtained.

The structure and shape of the carbon nanotubes may be selected depending on the circumstances and desired use. For instance, single-walled carbon nanotubes, double-walled carbon nanotubes, multi-walled carbon nanotubes, bundle-type carbon nanotubes, or a mixture thereof may be optionally employed without limitation.

The carbon nanotubes may be selectively included in the complex at a proper ratio depending on the use and case. For example, the ratio may be in the amount of about 0.1-90% by weight. If the amount of the carbon nanotube is less or more than the range, there may be problems with the deterioration of mechanical properties, conductivity, and dispersability.

The polymer binder acts to afford strong binding affinity and adhesiveness to the carbon nanotube-polymer complex and may be able to give various functionalities depending on the kind of polymer binder added thereto. There is no particular limitation on the kind of polymer binder that may be used, and particular examples thereof may include one or more selected from non-conductive polymers, conductive polymers, or a mixture thereof.

More particularly, the non-conductive polymers may include, but are not limited to, polyester, polycarbonate, polyvinylalcohol, polyvinylbutyral, polyacetal, polyarylate, polyamide, polyamideimide, polyetherimide, polyphenylene ether, polyphenylene sulfide, polyether sulfone, polyetherketone, polypthalamide, polyethernitrile, polyethersulfone, polybenzimidazole, polycarbodiimide, polysiloxane, polymethylmetacrylate, polymetacrylamide, nitrile rubber, acryl rubber, polyethylenetetrafluoride, epoxy resin, phenol resin, melamine resin, urea resin, polybutene, polypentene, ethylene-propylene copolymer, ethylene-butene-diene copolymer, polybutadiene, polyisoprene, ethylene-propylene-diene copolymer, butylrubber, polymethylpentene, polystyrene, styrene-butadiene copolymer, hydrogenated styrene-butadiene copolymer, hydrogenated polyisoprene, hydrogenated polybutadiene, and the like, and may be used alone or in the form of a mixture thereof.

The conductive polymers may include, but are not limited to, polyacetylene, polythiophene, poly(3-alkyl)thiophene, polypyrrole, polyisocyanapthalene, polyethylene dioxythiophene, polyparaphenylenevinylene, poly(2,5-dialkoxy)paraphenylenevinylene, polyparaphenylene, polyheptadiene, poly(3-hexyl)thiophene, polyaniline, and the like, and may be used alone or in the form of a mixture thereof.

The polymer binder may be selectively included in the complex at a proper ratio by considering their uses and cases. For example, the polymer binder may be included in the amount of about 0.1-99% by weight.

The multicomponent carbon nanotube-polymer complex may further include metallic nanoparticles, thereby exhibiting improved electrical characteristics. Examples of suitable metallic nanoparticles include one or more nanoparticles of gold, silver, copper, palladium, nickel, and platinum, but are not limited to such, and may include other metallic nanoparticles known or appreciated in the art.

The metallic nanoparticles may be selectively included in the complex at a proper ratio depending to the uses and cases thereof. For example, the metallic nanoparticles may be included in the amount of about 0.001-20% by weight.

Example embodiments also relate to a composition for forming a multicomponent carbon nanotube-polymer complex. A composition for forming a multicomponent carbon nanotube-polymer complex may include carbon nanotubes surface-modified with double bond-containing functional groups; a polymer binder; and a crosslinking agent (e.g., radical initiator).

A composition for forming a multicomponent carbon nanotube-polymer complex may also include carbon nanotubes surface-modified with double bond-containing functional groups; a polymer binder; acid-treated carbon nanotubes and/or pristine carbon nanotubes; and a crosslinking agent (e.g., radical initiator).

A composition for forming a multicomponent carbon nanotube-polymer complex may also include carbon nanotubes surface-modified with oxirane groups and/or carbon nanotubes surface-modified with anhydride groups; a polymer binder; acid-treated carbon nanotubes and/or pristine carbon nanotubes; and a crosslinking agent (e.g., thermal hardener).

The composition may be prepared by mixing the respective ingredients at a proper ratio by considering their uses and cases. For example, the composition may be prepared according to the following ratios, but is not limited thereto:
(1) about 0.01-70% by weight of carbon nanotubes surface-modified with double bond-containing functional groups; about 0.1-99% by weight of a polymer binder; and about 0.01-30% by weight of a radical initiator;
(2) about 0.01-50% by weight of carbon nanotubes surface-modified with double bond-containing functional groups; about 0.1-99% by weight of a polymer binder; about 0.01-50% by weight of acid-treated carbon nanotubes and/or about 0.1-90% by weight of pristine carbon nanotubes; and about 0.01-30% by weight of a radical initiator; and
(3) about 0.01-50% by weight of carbon nanotubes surface-modified with oxirane groups and/or carbon nanotubes surface-modified with anhydride groups; about 0.1-99% by weight of a polymer, binder; about 0.01-50% by weight of acid-treated carbon nanotubes and/or about 0.1-90% by weight of pristine carbon nanotubes; and about 0.01-30% by weight of a thermal hardener.

Mechanical and electrical properties of a multicomponent carbon nanotube-polymer complex may be regulated to desired ranges by controlling the mixing ratio between the carbon nanotubes and the polymer binder.

The radical initiator may include any heatcuring type initiator which may be degraded by heat and stimulate the initiation of radical polymerization (curing), and examples thereof may include, but are not limited to, one or more of peroxide-based or azo-based initiators.

The peroxide-based initiators may include, but are not limited to, benzoyl peroxide, t-butyl peroxylaurate, 1,1,3,3-t-methylbutylperoxy-2-ethylhexanoate, 2,5-dimethyl-2,5-di(2-ethylhexanoyl peroxy) hexane, 1-cyclohexyl-1-methylethyl peroxy-2-ethylhexanoate, 2,5-dimethyl-2,5-di(m-toluoyl peroxy) hexane, t-butyl peroxy isopropyl monocarbonate, t-butyl peroxy-2-ethylhexyl monocarbonate, t-hexyl peroxy benxoate, t-butyl peroxy acetate, dicumyl peroxide, 2,5,-dimethyl-2,5-di(t-butyl peroxy) hexane, t-butyl cumyl peroxide, t-hexyl peroxy noedecanoate, t-hexyl peroxy-2-ethylhexanoate, t-butyl peroxy-2-2-ethylhexanoate, t-butyl peroxy isobutylate, 1,1-bis(t-butyl peroxy)cyclohexane, t-hexyl peroxy isopropyl monocarbonate, t-butyl peroxy-3,5,5-trimethyl hexanoate, t-butyl peroxy pivalate, cumyl peroxy noedecanoate, di-iso-propyl benzene hydroperoxide, cumene hydroperoxide, iso-butyl peroxide, 2,4-dichlorobenzoyl peroxide, 3,5,5-trimethyl hexanoyl peroxide, octanoyl peroxide, lauroyl peroxide, lauryl peroxide, stearoyl peroxide, succinic peroxide, 3,5,5-trimethyl hexanoyl peroxide, benzoyl peroxy toluene, 1,1,3,3-tetramethyl butyl peroxy noedecanoate, 1-cyclohexyl-1-methyl ethyl peroxy noedecanoate, di-n-propyl peroxy dicarbonate, di-iso-propyl peroxy carbonate, bis(4-t-butyl cyclohexyl) peroxy dicarbonate, di-2-ethoxy methoxy peroxy dicarbonate, di(2-ethyl hexyl peroxy) dicarbonate, dimethoxy butyl peroxy dicarbonate, di(3-methyl-3-methoxy butyl peroxy)dicarbonate, 1,1-bis(t-hexyl peroxy)-3,3,5-trimethyl cyclohexane, 1,1-bis(t-hexyl peroxy)cyclohexane, 1,1-bis(t-butyl peroxy)-3,3,5-trimethyl cyclohexane, 1,1-(t-butyl peroxy)cyclododecane, 2,2-bis(t-butyl peroxy)decane, t-butyl trimethyl sylyl peroxide, bis(t-butyl)dimethyl sylyl peroxide, t-butyl trialyl sylyl peroxide, bis(t-butyl)dialyl sylyl peroxide, tris(t-butyl)aryl sylyl peroxide, and the like.

The azo-based initiators may include, but are not limited to, 2,2′-azobis(4-methoxy-2,4-dimethyl valeronitrile), dimethyl 2,2′-azobis(2-methylpropionate), 2,2′-azobis(N-cyclohexyl-2-methylpropionate, 2,2-azobis(2,4-dimethyl valeronitrile), 2,2′-azobis(2-methylbutylonitrile), 2,2′-azobis[N-(2-prophenyl)-2-methylpropionate, 2,2′-azobis(N-butyl-2-methylpropionate, 2,2′-azobis[N-(2-prophenyl)-2-methylpropionate, 1,1′-azobis(cyclohexan-1-carbonitril), 1-[(cyano-1-methylethyl)azo]formamide, and the like.

The radical initiator may be included in the amount of about 0.001-30% by weight based on the carbon nanotubes. If the radical initiator substantially exceeds the range, storage stability and curing may be deteriorated.

There is no particular limitation on the kind of a thermal hardener, which may be an epoxy thermal hardener, and examples thereof may include amines, anhydrides, imidazoles, arylphenols, carboxylic acids, polyamido-amine resin, polyamide resin, boron trifluoride, tris(β-methyl glycidyl)isocyanurate, bis(β-methyl glycidyl)terephthalate, p-phenolsulfonic acid, and the like, and may be used alone or in the form of a mixture.

Amines may generally be classified into two groups: non-aromatic and aromatic. Examples of non-aromatic amine-based thermal hardener may include, but are not limited to, 1,3-diaminopropane, 1,4-diaminobutane, ethylenediamine, diethylaminopropylamine, dimethylamine, trimethylhexamethylenediamine, diethylene triamine, triethylene tetramine, diethylamino propylamine, menthane diamine, 1,1-dimethylhydrazine, N-(3-aminopropyl)1,3-propanediamine, spermidine, spermine, 3,3′-diamino-N-methyldipropylamine, cyclopropylamine, cyclopentylamine, cyclohexylamine, cyclopentylamine, cyclooctylamine, cyclododecylamine, exo-2-aminorbornane, 1-adamantanamine, 4,4′-methylenbis(cyclohexylamine), isophorone diamine, ethanolamine, 2-hydroxyethylhydrazine, 3-amino-1-propanol, 5-amino-1-pentanol, serinol, 2-(2-Aminoethylamino)-ethanol, 3-pyrrolidinol, piperidine, hexamethyleneimine, piperazine, N-aminoethylpiperazine and 1,4,7-triazacyclononane; and examples of aromatic amine-based thermal hardener may include benzyl dimethyl amine, aniline, 4,4′-dimethyl aniline, diphenylamine, N-phenylbenzylamine, hexamethylene diamine, meta phenylene diamine, 2-methyl pentadimethylenediamine, 2-methyl hexamethylene diamine, 3-methyl hexamethylene diamine, 2,5-dimethyl hexamethylene diamine, 2,2-dimethylpentamethylene diamine, 5-methylnonane diamine, dodecadimethylene diamine, 2,2,7,7-tetramethyl octamethylene diamine, metaxylylene diamine, paraxylene diamine, 2-aminophenol, 3-fluoroaniline, 4,4′-ethylenedianiline, alkylaniline, 4-cyclohexylaniline, 3,3-methylenedianiline, 4,4′-methylenedianiline, 4-chloroaniline, 4-butoxyanline, 4-pentyloxyaniline, 4-hexyloxyaniline, 4,4′-oxydianline, 4″,4′″-(hexafluoroisopropylidene)-bis(4-phenoxyaniline), N,N-diglycidyl-4-glycidyloxyaniline, 4-aminophenol, 4,4′-thiodianiline, 4-aminophenethyl alcohol, 2,2-dimethylaniline, 4-fluoro-2-(trifluoromethyl)aniline, 4-fluoro-3-(trifluoromethyl)aniline, 5,5′-(hexafluoroisopropylidene)-di-O-toluidine, 4′-aminobenzo-15-crown-5,1,4-phenylenediamine, 2-aminobiphenyl, 4,4′-methylenbis(N,N-diglycidylaniline), 4,4′-methylenbis(N,N-diglycidylaniline), 4,4′-(hexafluoroisopropylidene)-dianiline, 4-phenoxyaniline, 3,3′-dimethoxybenidine, 2-aminonaphthalene, 2,3-diaminonapthalene, 1-8-diaminonaphthalene, 1-aminoanthracene, 2-aminoanthracene, 9-aminophenanthrene, 9,10-diaminophenanthrene, 3-aminofluoroanthene, 1-aminopyrene, 6-aminochrysene, phenylhydrazine, 1,2-diphenylhydrazine, 4-(trifluoromethyl)-phenylhydrazine, 2,3,5,6-tetrafluorophenylhydrazine, dibenzylamine, N,N′-dibenzylethylenediamine, N-benzyl-2-phenethylamine, 1-aminoindan, 1,2,3,4-tetrahydro-1-naphthylamine, 2-methylbenzylamine, 3,5-bis(trifluoromethyl)benzylamine, 3,4,5-trimethoxybenzylamine, indoline, 3-amino-1,2,4-triazine, 2-chloro-4,6-diamino-1,3,5-triazine, 2,4-diamino-6-methyl-1,3,5-triazine, 2,4,6-triaminopyrimidine, 2,4,5,6-tetraminopyrimidine sulfate, diamino diphenyl sulfone, tris(dimethyl-aminomethyl)phenol, dimethyl aminomethyl phenol), and the like.

Examples of the anhydride-based thermal hardener may include, but are not limited to, succinic anhydride, pentenyl succinic anhydride, hexenyl succinic anhydride, octenyl succinic anhydride, dodecenyl succinic anhydride, octadecenyl succinic anhydride, polyisobutenyl succinic anhydride, maleic anhydride, glutaric anhydride, cis-1,2-cyclohexanedicarbocylic anhydride, phenylmaleic anhydride, phthalic anhydride, 4,4′-(hexafluoroisopropylidene)-diphthalic anhydride, 4-methylphthalic anhydride, 3,6-difluorophthalic anhydride, 3,6-dichlorophthalic anhydride, 4,5-dichlorophthalic anhydride, tetrafluorophthalic anhydride, tetrachlorophthalic anhydride, tetrabromophthalic anhydride, 3-hydroxyphthalic anhydride, 1,2,4-benzenetricarboxylic anhydride, 3-nitrophthalic anhydride, 1,2,4,5-benznetetracarboxylic dianhydride, diphenic anhydride, 1,8-naphthalic anhydride, 4-chloro-1,8-naphthalic anhydride, 4-bromo-1,8-naphthalic anhydride, 4-amino-1,8-naphthalic anhydride, 1,4,5,8-naphthalenetetracarboxylic dianhydride, 3,4,9,10-perylenetetracarboxylic dianhydride, and the like.

Examples of the imidazole-based thermal hardener may include, but are not limited to, imidazole, 1-methylimidazole, 2-methylimidazole, 4-methylimidazole, 2-ethylimidazole, 2-propylimidazole, 2-isopropylimidazole, 1-butylimidazole, 2-undecylimidazole, 1,2-dimethylimidazole, 2-ethyl-4-methylimidazole, 1-decyl-2-methylimidazole, 1,5-dicyclohexylimidazole, 2,2′-bis(4,5-dimethylimidazole), 1-vinylimidazole, 1-allylimidazole, 5-choloro-1-methylimidazole, 5-chloro-1-ethyl-2-methylimidazole, 4,5-dichloroimidazole, 2,4,5-tribromoimidazole, 2-mercaptoimidazole, 2-mercapto-1-methylimidazole, 1-(3-aminopropyl)imidazole, 1-phenylimidazole, 2-phenylimidazole, 4-phenylimidazole, 4-(imidazol-1-yl)phenol, 1-benzylimidazole, 4-methyl-2-phenylimidazole, 1-benzyl-2-methylimidazole, 4,5-diphenylimidazole, 2,4,5-triphenylimidazole, 1-(2,3,5,6-tetrafluorophenyl)imidazole, 4,5-diphenyl-2-imiidazolethiol, histamine, 2-nitroimidazole, 4-nitroimidazole, 2-methyl-5-nitroimidazole, 2-imidazolecarboxaldehyde, 4-methyl-5-imidazolecarboxaldehyde, 1,1′-carbonylimidazole, 1,1′-oxalyldiimidazole, 1,1′-carbonylbis(2-methylimidazole), methyl-imidazolecarboxylate, 1-(tert-butoxycarbonyl)imidazole, 1-trans-cinnamoylimidazole, 1-(2-naphthoyl)imidazole, ethyl 4-methyl-5-imidazole-carboxylate, and the like.

Examples of the arylphenol-based thermal hardener may include, but are not limited to, m-cresol, o-cresol, p-cresol, 2,4-xylenol, 2,5-xylenol, 3,4-xylenol, 3,5-xylenol, thymol, catechol, pyrogallol, and the like.

Examples of the carboxylic acid-based thermal hardener may include, but are not limited to, acetic acid, formic acid, propionic acid, butyric acid, isobutyric acid, valeric acid, isovaleric acid, pivalic acid, hexanoic acid, and the like.

The thermal hardener may be included in the amount of about 0.01-30% by weight based on the carbon nanotubes. If the thermal hardener substantially exceeds the range, storage stability and curing may be deteriorated.

The composition may further include an organic solvent. Accordingly, a composition for forming a multicomponent carbon nanotube-polymer complex may include carbon nanotubes surface-modified with double bond-containing functional groups; a polymer binder; a radical initiator; and an organic solvent.

A composition for forming a multicomponent carbon nanotube-polymer complex may also include carbon nanotubes surface-modified with double bond-containing functional groups; a polymer binder; acid-treated carbon nanotubes and/or pristine carbon nanotubes; a radical initiator; and an organic solvent.

A composition for forming a multicomponent carbon nanotube-polymer complex may also include carbon nanotubes surface-modified with oxirane groups and/or carbon nanotubes surface-modified with anhydride groups; a polymer binder; acid-treated carbon nanotubes and/or pristine carbon nanotubes; a thermal hardener; and an organic solvent.

One or more organic solvents conventionally used in the art may be utilized as the organic solvent. In terms of miscibility, dispersability, and facility of a thin film formation, examples may include dimethylformamide (DMF), 4-hydroxy-4-methyl-2-pentanone, ethyleneglycolmonoethylether, 2-methoxyethanol, methoxypropylacetate, and ethyl-3-ethoxypropionate, cyclohexanone, and the like, and may be used alone or in the form of a mixture thereof. There is no particular limitation on the amount of such an organic solvent used therein, and it may be for example employed in the amount of about 0.1-98% by weight based on the carbon nanotube.

The composition may further include various additives, for example, metallic nanoparticles, coupling agents, dyes, fillers, flame-retarding agents, dispersing agents, wetting agents, and so forth, depending on the intended use of a carbon nanotube-polymer complex. Metallic nanoparticles may be added to the composition for further improved electrical characteristics (e.g., conductivity) to the complex.

To further improve the toughness of a final coating film to the complex, one or more coupling agents may be optionally added to the composition, and examples thereof may include aminopropyltriethoxysilane, phenylaminopropylmethoxysilane, ureidopropyltriethoxysilane, glycidoxypropyltrimethoxysilane, isocyanatopropyltriethoxysilane, isopropyltriisostearoyltitanate, acetoalkoxyaluminum diisopropylate, and the like, but are not necessary limited thereto.

Additives, including dyes, fillers, flame-retarding agents, dispersing agents, and wetting agents, may be employed depending on the intended use of the carbon nanotube-polymer complex. The additives may be included in the composition at a proper ratio depending on the use and case. For example, additives may be included in the amount of about 0.001-20% by weight.

The composition including carbon nanotubes surface-modified with double bond-containing functional groups may further include a double bond-containing monomer, oligomer, or polymer, regardless of the type of the functional groups appending to the surface-modified carbon nanotubes.

The composition including carbon nanotubes surface-modified with oxirane groups or anhydride groups may further include oxirane group-containing monomer or anhydride group-containing monomer, oligomer, or polymer, regardless of the type of the functional groups appending to the surface-modified carbon nanotubes. The monomer, oligomer, or polymer may provide crosslinking reactions with the surface-modified carbon nanotubes in the course of radical curing by heat or epoxy curing to yield increased properties and various functionalities to the carbon nanotube-polymer complex.

Double bond-containing monomers suitable for this purpose are not particularly limited and may be exemplified by methylmetaacrylate, arylacrylate, benzylacrylate, butoxyethylacrylate, 2-cyanoethylacrylate, cyclohexylacrylate, dicyclopentanylacrylate, N,N-diethylaminoethyl acrylate, 2-ethoxyethylacrylate, 2-ethylhexylacrylate, glycerolmetacrylate, glycidylmetacrylate, and the like. Furthermore, oxirane group-containing resins may be exemplified by epoxyacrylate derivatives, commercial epoxy resins having a glycidyl ether group, and so forth.

There is no particular limitation on the amount of the monomer, oligomer, or polymer that may be used therein. For example, the monomer, oligomer, or polymer may be added in the amount of about 0.001-80% by weight based on the carbon nanotube.

Example embodiments also relate to methods for preparing the multicomponent carbon nanotube-polymer complex. The multicomponent carbon nanotube-polymer complex may be prepared by the following method, but is not limited thereto.

The multicomponent carbon nanotube-polymer complex may be prepared by a method including (a) preparing the composition according to example embodiments and (b) obtaining a multicomponent carbon nanotube-polymer complex by mechanically mixing and curing the composition.

Alternatively, the complex may be prepared by a method including: (i) preparing the composition containing an organic solvent according to example embodiments; and (ii) obtaining a multicomponent carbon nanotube-polymer complex by coating the surface of a substrate with the composition and curing the composition.

For example, the composition in (a) may be a composition including carbon nanotubes surface-modified with double bond-containing functional groups, a polymer binder, and a radical initiator; a composition including carbon nanotubes surface-modified with double bond-containing functional groups, a polymer binder, acid-treated carbon nanotubes and/or pristine carbon nanotubes, and a radical initiator; or a composition including carbon nanotubes surface-modified with oxirane groups and/or carbon nanotubes surface-modified with anhydride groups, a polymer binder, acid-treated carbon nanotubes and/or pristine carbon nanotubes, and a thermal hardener.

Further, the composition in (i) may be a composition further including an organic solvent in the composition used in (a), for example, a composition including carbon nanotubes surface-modified with double bond-containing functional groups, a polymer binder, a radical initiator, and an organic solvent; a composition including carbon nanotubes surface-modified with double bond-containing functional groups, a polymer binder, acid-treated carbon nanotubes and/or pristine carbon nanotubes, a radical initiator, and an organic solvent; or a composition including carbon nanotubes surface-modified with oxirane groups and/or carbon nanotubes surface-modified with anhydride groups, a polymer binder, acid-treated carbon nanotubes and/or pristine carbon nanotubes, a thermal hardener, and an organic solvent.

In the preparation method of using the composition including the carbon nanotubes surface-modified with double bond-containing functional groups, the multicomponent carbon nanotube-polymer complex may be obtained by causing cross-linking reactions between the double bonds of the functional groups through radical polymerization, which may be initiated by radicals generated by heat in the procedure of mechanically heatcuring the composition or heatcuring by coating it on a substrate in the form of a film; and forming interpenetrating polymer network structures between the carbon nanotubes or the carbon nanotubes and the polymer binders.

In the preparation method of using the composition including the carbon nanotubes surface-modified with oxirane groups or anhydride groups, the multicomponent carbon nanotube-polymer complex may be obtained by causing cross-linking reactions between the functional groups through ring opening polymerization, which may be stimulated by a thermal hardener in the procedure of mechanically mixing and heatcuring the composition or heatcuring by coating it on a substrate in the form of a film; and forming interpenetrating polymer network structures between the carbon nanotubes or the carbon nanotubes and the polymer binders.

An example method of preparation will be described in more detail below.

(a):

Carbon nanotubes surface-modified with double bond-containing functional groups may be dispersed in a polymer binder selected according to the use thereof, together with one or more radical initiators, to prepare a composition for forming a multicomponent carbon nanotube-polymer complex.

Carbon nanotubes surface-modified with double bond-containing functional groups and acid-treated carbon nanotubes and/or pristine carbon nanotubes may be dispersed in a polymer binder selected according to the use thereof, together with one or more radical initiators, to prepare a composition for forming a multicomponent carbon nanotube-polymer complex.

Carbon nanotubes surface-modified with oxirane groups or anhydride groups and acid-treated carbon nanotubes and/or pristine carbon nanotubes may be dispersed in a polymer binder selected according to the use thereof, together with one or more thermal hardeners, to prepare a composition for forming a multicomponent carbon nanotube-polymer complex.

Other additives, including metallic nanoparticles, coupling agents, dispersing agents, and the like, may be selectively added to the composition depending on the particular use and case thereof.

(b):

The composition obtained in (a) may be mixed and cured by a mechanical method to thereby obtain a carbon nanotube-polymer complex.

The above-mentioned mechanical method may include all mechanical methods known or appreciated in the art which are able to cure a composition, and particular examples thereof may include, but are not limited to, the extrusion method, injection molding method, casting method, and the like.

It may be beneficial to use the extrusion method to prepare a composition in the form of a pellet with an extruder or the injection molding method to injection-mold a composition into various shapes with a desired mold. Furthermore, it may be beneficial to disperse or mix particles thoroughly within the composition by using a mixer or ultrasonification prior to proceeding with the extrusion or injection molding procedure.

This may be processed with the selected mechanical method under typical conditions, and for instance, the extrusion method may be conducted at about 200-400° C. (e.g., about 250-350° C.) for about 10 minutes to about 24 hrs (e.g., about 1-10 hrs).

The latter portion of the preparation method will be described in more detail below.

(i):

Carbon nanotubes surface-modified with double bond-containing functional groups and one or more polymer binders may be dispersed in an organic solvent, together with one or more radical initiators, to prepare a composition for forming a multicomponent carbon nanotube-polymer complex.

Carbon nanotubes surface-modified with double bond-containing functional groups, one or more polymer binders, and acid-treated carbon nanotubes and/or pristine carbon nanotubes may be dispersed in an organic solvent, together with one or more radical initiators, to prepare a composition for forming a multicomponent carbon nanotube-polymer complex.

Carbon nanotubes surface-modified with oxirane groups or anhydride groups, one or more polymer binders, and acid-treated carbon nanotubes and/or pristine carbon nanotubes may be dispersed in an organic solvent, together with one or more thermal hardeners, to prepare a composition for forming a multicomponent carbon nanotube-polymer complex.

Other additives, including metallic nanoparticles, coupling agents, dispersing agents, and the like, may be selectively added to the composition depending on the particular use and case thereof.

(ii):

The composition obtained in (i) may be used to coat the surface of a substrate, which may then be cured to obtain a carbon nanotube-polymer complex.

The materials for the substrate are not particularly limited. For instance, a glass substrate, a silicon wafer, or a plastic substrate may be selectively employed depending on the use thereof. The coating method using the composition may be a conventional coating or printing method, including spin coating, dip coating, spray coating, flow coating, screen printing, imprinting, roll printing, inkjet printing, dip pen printing, contact printing, or the like, but is not necessarily limited thereto. Printing, screen printing, and spin coating may be useful in light of their convenience, evenness, and scale-up. For spin coating, it may be beneficial to maintain the spin rate within the range of about 500-3500 rpm.

Curing may be carried out under typical conditions known in the art, and for instance, the substrate coated with the composition may be treated with heat at a temperature of about 65-200° C. for about 10 minutes to about 10 hrs.

Before the composition is used to coat the surface of the substrate, it may be beneficial to mix it by ultrasonification so as to uniformly disperse each particle therein.

Example embodiments will now be described in more detail with reference to the following examples. However, the examples are merely provided for purposes of illustration and are not to be construed as limiting the scope of the disclosure.

### Preparation Example 1

### Purification of Carbon Nanotubes

In a 500-ml flask equipped with a reflux tube, about 100 mg of carbon nanotubes (ILJIN CNT AP-Grade, Iljin Nanotech Co., Ltd., Korea) was refluxed with about 50 ml of distilled water at about 100° C. for about 12 hrs. After the refluxing was completed, the carbon nanotubes were filtered through a filter, dried at about 60° C. for about 12 hrs, and washed with toluene so as to remove residual fullerene. Next, the remaining soot was recovered from the flask, heated in a furnace at a temperature of about 470° C. for about 20 minutes, and lastly washed with about 6 M HCl solution, to obtain pristine carbon nanotubes without metallic impurities.

### Preparation Example 2

### Surface-Modification of Carbon Nanotubes with Carboxyl Groups

In a sonicator filled with a mixed acid solution of nitric acid and sulfuric acid (at a volume ratio of about 7:3 (v/v)), the pristine carbon nanotubes obtained in Preparation Example 1 were refluxed for about 24 hrs. Next, the carbon nanotubes were filtered through a polycarbonate filter of about 0.2 μm, refluxed again in nitric acid at about 90° C. for about 45 hrs, and centrifuged at about 12,000 rpm. The resulting supernatant was then filtered through a polycarbonate filter of about 0.1 μm. Subsequently, carbon nanotubes recovered through the filtration were dried at about 60° C. for about 12 hrs, dispersed in DMF, and filtrated again through a polycarbonate filter of about 0.1 μm for selective use thereof.

### Preparation Example 3

### Surface-Modification of Carbon Nanotubes with Acetylchloride Groups

In a flame-dried, 2-neck Schrenk flask under a nitrogen atmosphere, about 0.03 g of the carboxylated carbon nanotubes obtained in Preparation Example 2 was homogeneously dispersed in about 20 ml of DMF by ultrasonification for about 1 hr. Next, to the dispersion was added about 20 ml of thionylchloride, and the reaction mixture was stirred and reacted at about 70° C. for about 24 hrs. After the reaction was completed, the reaction mixture was diluted with anhydrous THF and centrifuged. Then, the resulting supernatant was discarded and the remaining dark pellet was washed about three times with anhydrous THF. Black solid matter thus purified was subjected to vacuum drying at room temperature to obtain acetylchlorinated carbon nanotubes.

### Preparation Example 4

### Surface-Modification of Carbon Nanotubes with Oxirane Groups

About 40 mg of the acetylchlorinated carbon nanotubes obtained in Preparation Example 3 was homogeneously dispersed in about 20 ml of chloroform by ultrasonification for about 30 minutes. Next, to the dispersion were sequentially added about 4 ml of pyridine and about 1 ml of glycidol. The reaction mixture was then stirred and reacted for about 48 hrs with refluxing. After the reaction was completed, the reaction mixture was washed with methanol several times so as to remove unreacted glycidol. The resulting black solid matter was subjected vacuum drying at room temperature, to thereby obtain carbon nanotubes modified with glycidylether groups.

### Preparation Example 5

### Surface-Modification of Carbon Nanotubes with Anhydride Groups

About 40 mg of the acetylchlorinated carbon nanotubes obtained in Preparation Example 3 was homogeneously dispersed in about 2 ml of dimethylformamide by ultrasonification. Next, to the dispersion were sequentially added about 10 ml of pyridine and about 2 g of 4-hydroxypthalic acid dimethylester. The reaction mixture was then stirred and reacted at about 70° C. for about 18 hrs. After the reaction was completed, the reaction mixture was washed with distilled water several times. To the resulting black solid matter were sequentially added about 20 ml of acetone and about 0.2 g of sodium hydroxide dissolved in about 10 ml of distilled water, followed by stirring and reacting at about 60° C. for about 18 hrs. Upon completion of the reaction, the reaction mixture was washed with watery HCl solution, distilled water, and ethylacetate several times, separately, and then, subjected to vacuum drying at room temperature. The dried solid matter was reacted with about 5 ml of acetic acid and about 5 ml of acetic anhydride at about 125° C. for about 8 hrs, followed by washing with methanol several times to remove unreacted substances. The solid matter thus purified was subjected vacuum drying at room temperature, to thereby obtain carbon nanotubes modified with anhydride groups.

### Preparation Example 6

### Surface-Modification of Carbon Nanotubes with Double Bond-Containing Functional Groups(1)

About 0.03 g of the carboxylated carbon nanotubes obtained in Preparation Example 2 was added to about 20 ml of DMF and evenly dispersed by ultrasonification for about 1 hr. Next, about 10 ml of TEA was dissolved in about 20 ml of DMF, and added to the carbon nanotube dispersion, and the mixture was stirred for about 1 hr. Then, the dispersion was moved to an ice-bath for cooling reaction heat, and about 5 ml of acryloyl chloride dissolved in about 100 ml of DMF was slowly dropped into the dispersion over a period of about 2 hrs with stirring and the mixture was allowed to further react at room temperature for about 24 hrs. After the reaction was completed, about 300 ml of distilled water was added to the reaction mixture, and the resulting precipitate was recovered from a polycarbonate filter of about 0.2 μm. The recovered precipitate was washed with water and diethylether about three times, separately, so as to remove unreacted acryloyl chloride. The washed precipitate was dried under reduced pressure at room temperature, to thereby obtain about 0.02 g of acrylated carbon nanotubes. The existence of acryl groups on the surfaces of the carbon nanotubes was examined by Raman spectrum.

### Preparation Example 7

### Surface-Modification of Carbon Nanotubes with Double Bond-Containing Functional Groups(2)

About 0.03 g of the carboxylated carbon nanotubes obtained in Preparation Example 2 was added to about 20 ml of DMF and homogeneously dispersed by ultrasonification for about 1 hr. Next, about 12 ml of TEA was dissolved in about 20 ml of DMF and added to the carbon nanotube dispersion, and the mixture was stirred for about 1 hr. Then, the dispersion was moved to an ice-bath for cooling reaction heat, and about 8 ml of vinylbenzyl chloride dissolved in about 100 ml of DMF was gently dropped into the dispersion over a period of about 2 hrs with stirring and the mixture was allowed to further react at room temperature for about hrs. After the reaction was completed, about 400 ml of distilled water was added to the reaction mixture, and the resulting precipitate was recovered from a polycarbonate filter of about 0.2 μm. The recovered precipitate was washed with water and diethylether about three times, separately, to remove unreacted vinylbenzyl chloride. The washed precipitate was dried under reduced pressure at room temperature, to thereby obtain about 0.015 g of vinylbenzylated carbon nanotubes. The existence of vinylbenzyl groups on the surfaces of the carbon nanotubes was examined by Raman spectrum.

### Example 1

### Formation of Multicomponent Carbon Nanotube-Polymer Complex(1)

The composition for forming a multicomponent carbon nanotube-polymer complex was prepared by using the carbon nanotubes surface-modified with oxirane groups obtained in Preparation Example 4 and carbon nanotubes surface-modified with carboxyl groups obtained in Preparation Example 2 according to the following composition:

| | | |
|---|---|---|
| Carbon nanotubes obtained in Preparation Example 4 | ~10.5 | g |
| Carbon nanotubes obtained in Preparation Example 2 | ~1.0 | g |
| Polycarbonate (Mw 25,000) | ~388 | g |
| Thermal hardener (ethylenediamine) | ~0.5 | g |

After mixing the ingredients thoroughly with a mixer for about 1 hr, the resulting mixture was extruded with a Twin excruder (Bau Technology, Model L40/D11) at about 270° C., and the extruded wire was cut by means of a pelletizer, to thereby prepare a multicomponent carbon nanotube-polymer complex in the form of a pellet.

### Example 2

### Formation of Multicomponent Carbon Nanotube-Polymer Complex(2)

The multicomponent carbon nanotube-polymer complex in the form of a pellet was prepared by the same method as described in Example 1, except that the composition was prepared according to the following composition:

| | | |
|---|---|---|
| Carbon nanotubes obtained in Preparation Example 4 | ~1.5 | g |
| Carbon nanotubes obtained in Preparation Example 1 | ~10 | g |
| Polycarbonate (Mw 25,000) | ~388 | g |
| Thermal hardener (ethylenediamine) | ~0.5 | g |

### Example 3

### Formation of Multicomponent Carbon Nanotube-Polymer Complex(3)

The multicomponent carbon nanotube-polymer complex in the form of a pellet was prepared by the same method as described in Example 1, except that the composition was prepared according to the following composition:

| | | |
|---|---|---|
| Carbon nanotubes obtained in Preparation Example 4 | ~0.5 | g |
| Carbon nanotubes obtained in Preparation Example 2 | ~1.3 | g |
| Carbon nanotubes obtained in Preparation Example 1 | ~10 | g |
| Polycarbonate (Mw 25,000) | ~388 | g |
| Thermal hardener (ethylenediamine) | ~0.2 | g |

### Example 4

### Formation of Multicomponent Carbon Nanotube-Polymer Complex(4)

The multicomponent carbon nanotube-polymer complex in the form of a pellet was prepared by the same method as described in Example 1, except that the carbon nanotubes obtained in Preparation Example 5 were employed instead of the carbon nanotubes obtained in Preparation Example 4.

### Example 5

### Formation of Multicomponent Carbon Nanotube-Polymer Complex(5)

The multicomponent carbon nanotube-polymer complex in the form of a pellet was prepared by the same method as described in Example 2, except that the carbon nanotubes obtained in Preparation Example 5 were employed instead of the carbon nanotubes obtained in Preparation Example 4.

### Example 6

### Formation of Multicomponent Carbon Nanotube-Polymer Complex(6)

The multicomponent carbon nanotube-polymer complex in the form of a pellet was prepared by the same method as described in Example 3, except that the carbon nanotubes obtained in Preparation Example 5 were employed instead of the carbon nanotubes obtained in Preparation Example 4.

### Example 7

### Formation of Multicomponent Carbon Nanotube-Polymer Complex(7)

The multicomponent carbon nanotube-polymer complex in the form of a pellet was prepared by the same method as described in Example 1, except that the carbon nanotubes obtained in Preparation Example 6 were employed instead of the carbon nanotubes obtained in Preparation Example 4, and a radical initiator (benzoyl peroxide) was employed in place of the thermal hardener (ethylenediamine).

### Example 6

### Formation of Multicomponent Carbon Nanotube-Polymer Complex(8)

The multicomponent carbon nanotube-polymer complex in the form of a pellet was prepared by the same method as described in Example 2, except that the carbon nanotubes obtained in Preparation Example 6 were employed instead of the carbon nanotubes obtained in Preparation Example 4, and a radical initiator (benzoyl peroxide) was employed in place of the thermal hardener (ethylenediamine).

### Example 9

### Formation of Multicomponent Carbon Nanotube-Polymer Complex(9)

The multicomponent carbon nanotube-polymer complex in the form of a pellet was prepared by the same method as described in Example 3, except that the carbon nanotubes obtained in Preparation Example 6 were employed instead of the carbon nanotubes obtained in Preparation Example 4, and a radical initiator (benzoyl peroxide) was employed in place of the thermal hardener (ethylenediamine).

### Example 10

### Formation of Multicomponent Carbon Nanotube-Polymer Complex(10)

The multicomponent carbon nanotube-polymer complex in the form of a pellet was prepared by the same method as described in Example 1, except that the carbon nanotubes obtained in Preparation Example 7 were employed instead of the carbon nanotubes obtained in Preparation Example 4, and a radical initiator (benzoyl peroxide) was employed in place of the thermal hardener (ethylenediamine).

### Example 11

### Formation of Multicomponent Carbon Nanotube-Polymer Complex(11)

The multicomponent carbon nanotube-polymer complex in the form of a pellet was prepared by the same method as described in Example 2, except that the carbon nanotubes obtained in Preparation Example 7 were employed instead of the carbon nanotubes obtained in Preparation Example 4, and a radical initiator (benzoyl peroxide) was employed in place of the thermal hardener (ethylenediamine).

### Example 12

### Formation of Multicomponent Carbon Nanotube-Polymer Complex(12)

The multicomponent carbon nanotube-polymer complex in the form of a pellet was prepared by the same method as described in Example 3, except that the carbon nanotubes obtained in Preparation Example 7 were employed instead of the carbon nanotubes obtained in Preparation Example 4, and a radical initiator (benzoyl peroxide) was employed in place of the thermal hardener (ethylenediamine).

### Example 13

### Formation of Multicomponent Carbon Nanotube-Polymer Complex(13)

The multicomponent carbon nanotube-polymer complex in the form of a pellet was prepared by the same method as described in Example 1, except that the composition was prepared according to the following composition:

| | | |
|---|---|---|
| Carbon nanotubes obtained in Preparation Example 6 | ~48 | g |
| Polycarbonate (Mw 25,000) | ~350 | g |
| Radical initiator (benzoyl peroxide) | ~2 | g |

### Example 14

### Formation of Multicomponent Carbon Nanotube-Polymer Complex(14)

The composition for forming a multicomponent carbon nanotube-polymer complex was prepared by using the carbon nanotubes surface-modified with oxirane groups obtained in Preparation Example 4 and the carbon nanotubes surface-modified with carboxyl groups obtained in Preparation Example 2 according to the following composition:

| | | |
|---|---|---|
| Carbon nanotubes obtained in Preparation Example 4 | ~0.6 | g |
| Carbon nanotubes obtained in Preparation Example 2 | ~0.6 | g |
| Polycarbonate (Mw 25,000) | ~38.8 | g |
| Thermal hardener (ethylenediamine) | ~1 | g |
| Solvent (DMF) | ~10 | g |
| Solvent (methylenechloride) | ~400 | g |

After mixing the ingredients by ultrasonification for about 1 hr, the composition was coated on the surface of a flat glass culture dish (about 100 mm in diameter and about 10 mm in height), and the resulting dish was kept at about 80° C. for about 3 days so as to slowly evaporate the solvent, to thereby obtain a multicomponent carbon nanotube-polymer complex in the form of a film having an average thickness of about 0.4 mm.

### Example 15

### Formation of Multicomponent Carbon Nanotube-Polymer Complex(15)

The multicomponent carbon nanotube-polymer complex in the form of a film was prepared by the same method as described in Example 14, except that the composition was prepared according to the following composition:

| | | |
|---|---|---|
| Carbon nanotubes obtained in Preparation Example 4 | ~0.6 | g |
| Carbon nanotubes obtained in Preparation Example 1 | ~0.6 | g |
| Polycarbonate (Mw 25,000) | ~38.8 | g |
| Thermal hardener (ethylenediamine) | ~1 | g |
| Solvent (DMF) | ~10 | g |
| Solvent (methylenechloride) | ~400 | g |

### Example 16

### Formation of Multicomponent Carbon Nanotube-Polymer Complex(16)

The multicomponent carbon nanotube-polymer complex in the form of a film was prepared by the same method as described in Example 14, except that the composition was prepared according to the following composition:

| | | |
|---|---|---|
| Carbon nanotubes obtained in Preparation Example 4 | ~0.2 | g |
| Carbon nanotubes obtained in Preparation Example 2 | ~0.2 | g |
| Carbon nanotubes obtained in Preparation Example 1 | ~0.8 | g |
| Polycarbonate (Mw 25,000) | ~38.8 | g |
| Thermal hardener(ethylenediamine) | ~1 | g |
| Solvent (DMF) | ~10 | g |
| Solvent (methylenechloride) | ~400 | g |

### Example 17

### Formation of Multicomponent Carbon Nanotube-Polymer Complex(17)

The multicomponent carbon nanotube-polymer complex in the form of a film was prepared by the same method as described in Example 14, except that the carbon nanotubes obtained in Preparation Example 5 were employed instead of the carbon nanotubes obtained in Preparation Example 4.

### Example 18

### Formation of Multicomponent Carbon Nanotube-Polymer Complex(18)

The multicomponent carbon nanotube-polymer complex in the form of a film was prepared by the same method as described in Example 15, except that the carbon nanotubes obtained in Preparation Example 5 were employed instead of the carbon nanotubes obtained in Preparation Example 4.

### Example 19

### Formation of Multicomponent Carbon Nanotube-Polymer Complex(19)

The multicomponent carbon nanotube-polymer complex in the form of a film was prepared by the same method as described in Example 16, except that the carbon nanotubes obtained in Preparation Example 5 were employed instead of the carbon nanotubes obtained in Preparation Example 4.

### Example 20

### Formation of Multicomponent Carbon Nanotube-Polymer Complex(20)

The multicomponent carbon nanotube-polymer complex in the form of a film was prepared by the same method as described in Example 14, except that the carbon nanotubes obtained in Preparation Example 6 were employed instead of the carbon nanotubes obtained in Preparation Example 4, and a radical initiator (benzoyl peroxide) was employed in place of the thermal hardener (ethylenediamine).

### Example 21

### Formation of Multicomponent Carbon Nanotube-Polymer Complex(21)

The multicomponent carbon nanotube-polymer complex in the form of a film was prepared by the same method as described in Example 15, except that the carbon nanotubes obtained in Preparation Example 6 were employed instead of the carbon nanotubes obtained in Preparation Example 4, and a radical initiator (benzoyl peroxide) was employed in place of the thermal hardener (ethylenediamine).

### Example 22

### Formation of Multicomponent Carbon Nanotube-Polymer Complex(22)

The multicomponent carbon nanotube-polymer complex in the form of a film was prepared by the same method as described in Example 16, except that the carbon nanotubes obtained in Preparation Example 6 were employed instead of the carbon nanotubes obtained in Preparation Example 4, and a radical initiator (benzoyl peroxide) was employed in place of the thermal hardener (ethylenediamine).

### Example 23

### Formation of Multicomponent Carbon Nanotube-Polymer Complex(23)

The multicomponent carbon nanotube-polymer complex in the form of a film was prepared by the same method as described in Example 14, except that the carbon nanotubes obtained in Preparation Example 7 were employed instead of the carbon nanotubes obtained in Preparation Example 4, and a radical initiator (benzoyl peroxide) was employed in place of the thermal hardener (ethylenediamine).

### Example 24

### Formation of Multicomponent Carbon Nanotube-Polymer Complex(24)

The multicomponent carbon nanotube-polymer complex in the form of a film was prepared by the same method as described in Example 15, except that the carbon nanotubes obtained in Preparation Example 7 were employed instead of the carbon nanotubes obtained in Preparation Example 4, and a radical initiator (benzoyl peroxide) was employed in place of the thermal hardener (ethylenediamine).

### Example 25

### Formation of Multicomponent Carbon Nanotube-Polymer Complex(25)

The multicomponent carbon nanotube-polymer complex in the form of a film was prepared by the same method as described in Example 16, except that the carbon nanotubes obtained in Preparation Example 7 were employed instead of the carbon nanotubes obtained in Preparation Example 4, and a radical initiator (benzoyl peroxide) was employed in place of the thermal hardener (ethylenediamine).

### Example 26

### Formation of Multicomponent Carbon Nanotube-Polymer Complex(26)

The multicomponent carbon nanotube-polymer complex in the form of a film was prepared by the same method as described in Example 14, except that the composition was prepared according to the following composition:

| | | |
|---|---|---|
| Carbon nanotubes obtained in Preparation Example 7 | ~1.2 | g |
| Polycarbonate (Mw 25,000) | ~38.8 | g |
| Radical initiator (benzoyl peroxide) | ~3 | g |
| Solvent (DMF) | ~10 | g |
| Solvent (methylenechloride) | ~400 | g |

### Comparative Example 1

### Formation of Carbon Nanotube-Polymer Complex(1)

The carbon nanotube-polymer complex in the form of a pellet was prepared by the same method as described in Example 1, except that the composition was prepared according to the following composition:

| | |
|---|---|
| Carbon nanotubes obtained in Preparation Example 1 | ~12 g |
| Polycarbonate (Mw 25,000) | ~388 g |

### Comparative Example 2

### Formation of Carbon Nanotube-Polymer Complex(2)

The carbon nanotube-polymer complex in the form of a pellet was prepared by the same method as described in Example 1, except that the composition was prepared according to the following composition:

| | | |
|---|---|---|
| Carbon nanotubes obtained in Preparation Example 2 | ~12 | g |
| Polycarbonate (Mw 25,000) | ~388 | g |
| Thermal hardener (ethylenediamine) | ~1 | g |

### Comparative Example 3

### Formation of Carbon Nanotube-Polymer Complex(3)

The carbon nanotube-polymer complex in the form of a film was prepared by the same method as described in Example 14, except that the composition was prepared according to the following composition:

| | | |
|---|---|---|
| Carbon nanotubes obtained in Preparation Example 1 | ~1.2 | g |
| Polycarbonate (Mw 25,000) | ~38.8 | g |
| Solvent (DMF) | ~10 | g |
| Solvent (methylenechloride) | ~400 | g |

### Comparative Example 4

### Formation of Carbon Nanotube-Polymer Complex(4)

The carbon nanotube-polymer complex in the form of a film was prepared by the same method as described in Example 14, except that the composition was prepared according to the following composition:

| | | |
|---|---|---|
| Carbon nanotubes obtained in Preparation Example 2 | ~1.2 | g |
| Polycarbonate (Mw 25,000) | ~38.8 | g |
| Thermal hardener (ethylenediamine) | ~1 | g |
| Solvent (DMF) | ~10 | g |
| Solvent (methylenechloride) | ~400 | g |

### Comparative Example 5

### Formation of Carbon Nanotube-Polymer Complex(5)

The carbon nanotube-polymer complex in the form of a film was prepared by the same method as described in Comparative Example 4, except that the carbon nanotubes obtained in Preparation Example 4 were employed instead of the carbon nanotubes obtained in Preparation Example 2.

### Comparative Example 6

### Formation of Carbon Nanotube-Polymer Complex(6)

The carbon nanotube-polymer complex in the form of a film was prepared by the same method as described in Comparative Example 4, except that the carbon nanotubes obtained in Preparation Example 5 were employed instead of the carbon nanotubes obtained in Preparation Example 2.

Mechanical properties of the respective carbon nanotube-polymer complexes obtained in Examples 1 to 26 and Comparative Examples 1 to 6 were measured and shown in Table 1 below.

TABLE 1

| | Elastic | Tensile |
|---|---|---|
| | modulus | strength |
| | (MPa) | (MPa) |
| Example 1 | 4100 | 39 |
| Example 2 | 4100 | 39 |
| Example 3 | 4500 | 42 |
| Example 4 | 4300 | 39 |
| Example 5 | 4250 | 40 |
| Example 6 | 4550 | 43 |
| Example 7 | 3900 | 35 |
| Example 8 | 3900 | 38 |
| Example 9 | 4400 | 42 |
| Example 10 | 3800 | 39 |
| Example 11 | 4000 | 38 |
| Example 12 | 4400 | 43 |
| Example 13 | 4100 | 45 |
| Example 14 | 4200 | 38 |
| Example 15 | 4100 | 38 |
| Example 16 | 4500 | 41 |
| Example 17 | 4250 | 42 |
| Example 18 | 4100 | 41 |
| Example 19 | 4350 | 39 |
| Example 20 | 4200 | 39 |
| Example 21 | 4100 | 39 |
| Example 22 | 4300 | 43 |
| Example 23 | 4100 | 41 |
| Example 24 | 3900 | 45 |
| Example 25 | 4200 | 41 |
| Example 26 | 4150 | 39 |
| Comparative | 3700 | 34 |
| Example 1 | | |
| Comparative | 3800 | 35 |
| Example 2 | | |
| Comparative | 3700 | 35 |
| Example 3 | | |
| Comparative | 3800 | 35 |
| Example 4 | | |
| Comparative | 3900 | 36 |
| Example 5 | | |
| Comparative | 3700 | 35 |
| Example 6 | | |

*The above results were measured by AGS-100G (SHIMADZU Scientific Instruments Inc., USA) by using ASTM D882-97.

As shown in Table 1, the multicomponent carbon nanotube-polymer complexes exhibit about 10% or more increase in mechanical strength and curing property when compared to conventional complexes, which, for example, were obtained by simply mixing carbon nanotubes with a polymer binder. In contrast, example embodiments disclosed, for instance, a method involving the mixing of acid-treated carbon nanotubes with a polymer binder and curing the mixture, as well as a method involving the mixing of carbon nanotubes surface-modified with oxirane groups or anhydride groups with a polymer binder and curing the mixture.

The multicomponent carbon nanotube-polymer complex exhibits remarkably improved mechanical and hardening properties when compared with conventional complexes obtained from the simple blending of carbon nanotubes and a polymer binder, and thus may be more advantageously used as an electromagnetic wave shielding material and a conductive material.

While example embodiments have been disclosed herein, it should be understood that other variations may be possible. Such variations are not to be regarded as a departure from the spirit and scope of example embodiments of the present invention, and all such modifications as would be obvious to one skilled in the art are intended to be included within the scope of the following claims.

What is claimed is:

1. A multicomponent carbon nanotube-polymer complex, comprising:
carbon nanotubes surface-modified with oxirane groups, carbon nanotubes surface-modified with anhydride groups, or a mixture thereof;
a polymer binder; and
acid-treated carbon nanotubes, pristine carbon nanotubes, or a mixture thereof.

2. The multicomponent carbon nanotube-polymer complex of claim 1, wherein the oxirane group is represented by Formula (4), and the anhydride group is represented by one of the following Formulas (5)-(10): 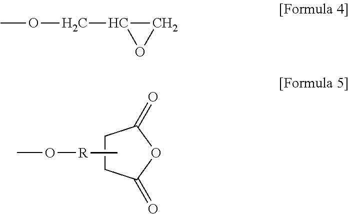
wherein R is C₁₋₁₅ linear, branched, or cyclic alkylene; and

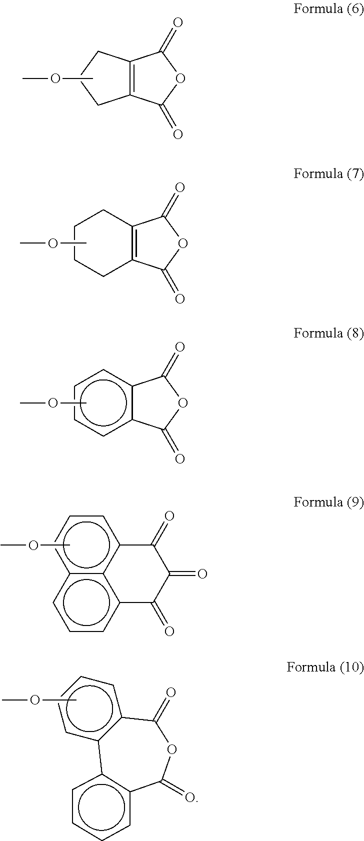

3. The multicomponent carbon nanotube-polymer complex of claim 1, wherein the polymer binder is a non-conductive polymer, a conductive polymer, or a mixture thereof.

4. The multicomponent carbon nanotube-polymer complex of claim 3, wherein the non-conductive polymer includes polyester, polycarbonate, polyvinylalcohol, polyvinylbutyral, polyacetal, polyarylate, polyamide, polyamideimide, polyetherimide, polyphenylene ether, polyphenylene sulfide, polyether sulfone, polyetherketone, polypthalamide, polyethernitrile, polyethersulfone, polybenzimidazole, polycarbodiimide, polysiloxane, polymethylmetacrylate, polymetacrylamide, nitrile rubber, acryl rubber, polyethylenetetrafluoride, epoxy resin, phenol resin, melamine resin, urea resin, polybutene, polypentene, ethylene-propylene copolymer, ethylene-butene-diene copolymer, polybutadiene, polyisoprene, ethylene-propylene-diene copolymer, butylrubber, polymethylpentene, polystyrene, styrene-butadiene copolymer, hydrogenated styrene-butadiene copolymer, hydrogenated polyisoprene, hydrogenated polybutadiene, or mixtures thereof.

5. The multicomponent carbon nanotube-polymer complex of claim 3, wherein the conductive polymer includes polyacetylene, polythiophene, poly(3-alkyl)thiophene, polypyrrole, polyisocyanapthalene, polyethylene dioxythiophene, polyparaphenylenevinylene, poly(2,5-dialkoxy)paraphenylenevinylene, polyparaphenylene, polyheptadiene, poly(3-hexyl)thiophene, polyaniline, or mixtures thereof.

6. The multicomponent carbon nanotube-polymer complex of claim 1, wherein the acid-treated carbon nanotubes are treated with nitric acid, sulfuric acid, or a mixture thereof.

7. The multicomponent carbon nanotube-polymer complex of claim 1, wherein the acid-treated carbon nanotubes are carbon nanotubes whose surfaces are modified with carboxyl groups.

8. The multicomponent carbon nanotube-polymer complex of claim 1, further comprising:
metallic nanoparticles.

9. The multicomponent carbon nanotube-polymer complex of claim 8, wherein the metallic nanoparticles include at least one of gold, silver, copper, palladium, nickel, and platinum.

10. The multicomponent carbon nanotube-polymer complex of claim 8, wherein the metallic nanoparticles are present in an amount of about 0.001-20% by weight.

11. A composition for forming the multicomponent carbon nanotube-polymer complex of claim 1, comprising:
the carbon nanotubes surface-modified with oxirane groups, carbon nanotubes surface-modified with anhydride groups, or a mixture thereof;
the polymer binder;
the acid-treated carbon nanotubes, pristine carbon nanotubes, or a mixture thereof; and
a crosslinking agent.

12. The composition of claim 11, wherein the composition includes:
about 0.01-50% by weight of the carbon nanotubes surface-modified with oxirane groups or about 0.01-50% by weight of the carbon nanotubes surface-modified with anhydride groups or a mixture thereof;
about 0.1-99% by weight of the polymer binder;
about 0.01-50% by weight of the acid-treated carbon nanotubes or about 0.1-90% by weight of the pristine carbon nanotubes or a mixture thereof; and
about 0.01-30% by weight of the crosslinking agent, wherein the crosslinking agent is a thermal hardener.

13. The composition of claim 11, wherein the crosslinking agent is a thermal hardener.

14. The composition of claim 13, wherein the thermal hardener is an epoxy thermal hardener that includes amines, anhydrides, imidazoles, arylphenols, carboxylic acids, polyamido-amine resin, polyamide resin, boron trifluoride, tris(β-methyl glycidyl)isocyanurate, bis(β-methyl glycidyl)terephthalate, p-phenolsulfonic acid, or mixtures thereof.

15. The composition of claim 11, further comprising:
an organic solvent.

16. The composition of claim 15, wherein the organic solvent is dimethylformamide (DMF), 4-hydroxy-4-methyl-2-pentanone, ethyleneglycolmonoethylether, 2-methoxyethanol, methoxypropylacetate, and ethyl-3-ethoxypropionate, cyclohexanone, or mixtures thereof.

17. The composition of claim 11, further comprising:
a coupling agent including aminopropyltriethoxysilane, phenylaminopropylmethoxysilane, ureidopropyltriethoxysilane, glycidoxypropyltrimethoxysilane, isocyanatopropyltriethoxysilane, isopropyltriisostearoyltitanate, acetoalkoxyaluminum diisopropylate, or mixtures thereof.

18. A method for preparing a multicomponent carbon nanotube-polymer complex, comprising:
preparing the composition of claim 11; and
mixing and curing the composition by a mechanical method to thereby obtain a multicomponent carbon nanotube-polymer complex.

19. The method of claim 18, wherein the mechanical method is an extrusion method, an injection molding method, or a casting method.

20. The method of claim 18, wherein the curing is conducted at about 200-400° C. for about 10 minutes to about 24 hrs.
